(19) United States
(12) Patent Application Publication
(10) Pub. No.: US 2015/0294421 A1
(43) Pub. Date: Oct. 15, 2015

(54) Workcenter For Processing Rejected Or Denied Claims In A Revenue Cycle Management System

(71) Applicant: ZIRMED, INC., Louisville, KY (US)

(72) Inventors: Douglas R. Fielding, Finchville, KY (US); James Scott Lacy, Shelbyville, KY (US); Eric L. Sinclair, III, Louisville, KY (US); Christopher L. Schremser, New Albany, IN (US)

(21) Appl. No.: 14/686,772

(22) Filed: Apr. 14, 2015

Related U.S. Application Data
(60) Provisional application No. 61/979,197, filed on Apr. 14, 2014.

(51) Int. Cl. G06Q 40/08; G06Q 10/06

(52) U.S. Cl. CPC G06Q 40/08; G06Q 10/06311

(57) ABSTRACT

A system is provided for resolving issues with adjudicated claims. The system includes a server equipped with a portal; a plurality of healthcare providers which are in communication with said server by way of said portal, and which submit rejected or denied healthcare claims to the portal from a plurality of source systems running a plurality of distinct healthcare practice management programs; and at least one software program installed on said server which, in response to user input, edits the submitted healthcare claims, thereby producing a plurality of edited claims.

### CROSS-REFERENCE TO RELATED APPLICATION

This application claims the benefit of U.S. provisional application No. 61/979,197 filed Apr. 14, 2014, having the same inventors and the same title, and which is incorporated herein by reference in its entirety.

### FIELD OF THE DISCLOSURE

The present disclosure relates generally to revenue cycle management, and more particularly to systems and methods for processing rejected or denied claims in a revenue cycle management system.

### BACKGROUND OF THE DISCLOSURE

As part of the revenue cycle in the healthcare industry, claims are presented to a payer (which may be an insurance company or other third party payer) for payment. The payer will typically apply a set of rules to determine whether the claim should be paid in part or in full, or should be rejected. A claim may be rejected for a variety of reasons such as, for example, the format the claim was presented in, the underlying services that gave rise to the claim, or the healthcare provider that provided those services.

Resolving issues with insurance claims is a complex and resource intensive endeavor in the healthcare industry, due in part to the large volume of claims which must be processed and adjudicated on a daily basis, and the various reasons for which a claim may be rejected. This is especially so in cases where human intervention is required.

Some systems have been developed in the art which attempt to address these needs. For example, General Electric's CENTRICITY™ Business Enterprise Task Manager is a healthcare revenue cycle solution which features an integrated set of workflows. This system includes a module for handling claim rejections in which rejected claims are categorized and prioritized, and then sent to an appropriate staff member for resolution.

### BRIEF DESCRIPTION OF THE DRAWINGS

FIGS. 1-9 are screenshots from a first particular, non-limiting embodiment of a system in accordance with the teachings herein.

### SUMMARY OF THE DISCLOSURE

In one aspect, a system is provided for resolving issues with adjudicated claims. The system includes a server equipped with a portal; a plurality of healthcare providers which are in communication with said server by way of said portal, and which submit rejected or denied healthcare claims to the portal from a plurality of source systems running a plurality of distinct healthcare practice management programs; and at least one software program installed on said server which, in response to user input, edits the submitted healthcare claims, thereby producing a plurality of edited claims.

In another aspect, a method for processing health insurance claims is provided. The method comprises (a) providing a server equipped with a portal, wherein a plurality of healthcare providers are in communication with the server by way of said portal, and wherein the server is equipped with software which allows a user to edit healthcare claims; (b) receiving rejected or denied healthcare claims through the portal from a plurality of source systems running a plurality of distinct healthcare practice management programs; (c) in response to inputs made by a user of the software, editing the healthcare claims, thereby producing a plurality of edited claims; and (d) propagating the edited claims to the plurality of source systems.

In a further aspect, a method is provided for processing health insurance claims. The method comprises (a) providing a server equipped with a portal, wherein a plurality of healthcare providers are in communication with the server by way of said portal, and wherein the server is equipped with software which allows a user to edit healthcare claims received through the portal; (b) defining a plurality of worker groups to which claims received through the portal are assigned, wherein defining a plurality of worker groups with the software includes assigning workers to each of the plurality of worker groups, and defining the types of claims to be assigned to each of the plurality of worker groups; (c) defining a set of priority rules with the software which determines the priority assigned to each claim received through the portal; (d) receiving rejected or denied healthcare claims through the portal from a plurality of source systems running a plurality of distinct healthcare practice management programs; (e) assigning each of the claims received through the portal to one of said worker groups; (f) arranging the claims assigned to each worker group in order of priority based on the priority rules, thereby creating a prioritized claims listing; (g) presenting claims from the prioritized claims listing to at least one member of the worker group to which the claims in the prioritized claims listing have been assigned, wherein the claims are presented in the order in which the claims were prioritized; (h) receiving inputs from the at least one member in the form of edits to the claims in the prioritized claims listing; (i) in response to inputs made by a user of the software, editing the healthcare claims, thereby producing a plurality of edited claims; and (j) propagating the edited claims to the plurality of source systems.

In yet another aspect, a tangible, non-transitive, computer readable medium is provided having programming instructions recorded therein which, when executed by at least one processor, perform the method of (a) creating a portal on a server associated with a revenue cycle management company, wherein a plurality of healthcare providers are in communication with the server by way of said portal, and wherein the server is equipped with software which allows a user to edit healthcare claims; (b) receiving rejected or denied healthcare claims through the portal from a plurality of source systems running a plurality of distinct healthcare practice management programs; (c) editing the healthcare claims in response to inputs from a party assigned to work the claim, thereby producing a plurality of edited claims; and (d) propagating the edited claims to the plurality of source systems.

### DETAILED DESCRIPTION

While the systems developed to date for processing claim adjudications may have some desirable features, they do not address some of the significant needs which still persist in the art. For example, many of these systems do not provide a means for efficiently prioritizing work on claims. Consequently, users of these systems often end up spending considerable amounts of time processing less important claims, while more important claims are ignored or processed in a less timely manner.

In addition, many healthcare organizations have multiple locations, accounts and structures, and utilize multiple practice management systems that may not be compatible with each other. Consequently, workers for these organizations must frequently switch between different systems in the process of resolving claim issues. This often involves duplicating work in one system that was originally performed in another system, or importing or transferring work or files from one system to another. Given the large number of healthcare claims that are processed on a daily basis, this results in a significant amount of worker inefficiency.

There is thus a need in the art for systems and methods for resolving issues with adjudicated claims which allow work on healthcare claims to be efficiently prioritized, and which allow work on claim adjudications to be performed only once and on a single system. These and other needs may be met by the systems and methods disclosed herein.

It has now been found that the foregoing needs may be addressed with the systems and methodologies disclosed herein. In a preferred embodiment, these systems and methodologies feature a portal that a user can log into and create or customize workgroups. Rejected or denied healthcare claims which meet certain user defined search criteria may then be placed into these workgroups for further processing. Such further processing will typically include editing the claims as necessary to place them into a condition so that they will be acceptable by the payer and may be resubmitted. In a preferred embodiment, when a worker is done editing the claim, a “resubmit” button or option is provided which, upon selection, resubmits the (edited) claim to the payer for reconsideration.

The system also allows a manager to assign work to a group of employees which are associated with the manager. In a preferred embodiment, a worker to whom work has been assigned by this manager logs into the system, and the claims which need to be processed by that worker then appear on the worker's screen in a prioritized listing. The prioritized listing may prioritize the claims, for example, by the highest priority workgroup that each claim fits the criteria of. The worker can then work through all of the highest priority claims (e.g., priority 1), and only after those claims have been processed will they reach the next highest priority claims (e.g., priority 2). In some embodiments, the foregoing may also be true of a group of workers to which work has been assigned by the manager. Preferably, as claims are rejected during the day and come into the system, as soon as one new priority 1 claim comes into the system, it is received by whichever user is next on the list for that priority.

The foregoing process governs the claims that the workers work on throughout the day, so that the workers are always working on the highest priority items as defined by users who are leveraging the (preferably cloud-based) system regardless of the facility or system type from which the claim m originated. Moreover, the workers who are processing the claims do not have to search for the next claim to work on, since the claims are presented in a single prioritized listing. Consequently, significant improvements may be achieved in worker efficiency as compared to prior art systems.

The systems and methodologies disclosed herein are especially useful when the portal is associated with a revenue cycle management company. In that case, the work coming into the system may be the actual electronic data interchange (EDI) transactions being processed by the revenue cycle management company.

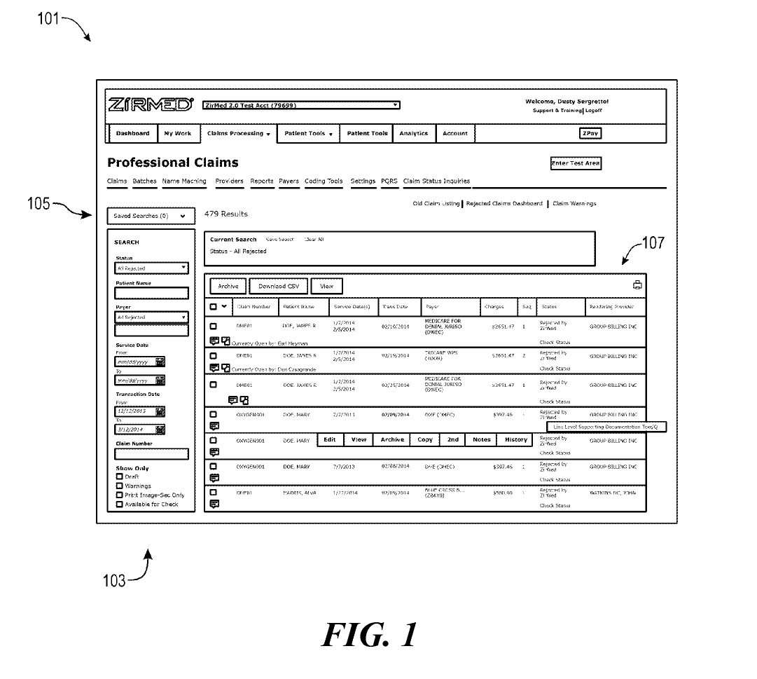

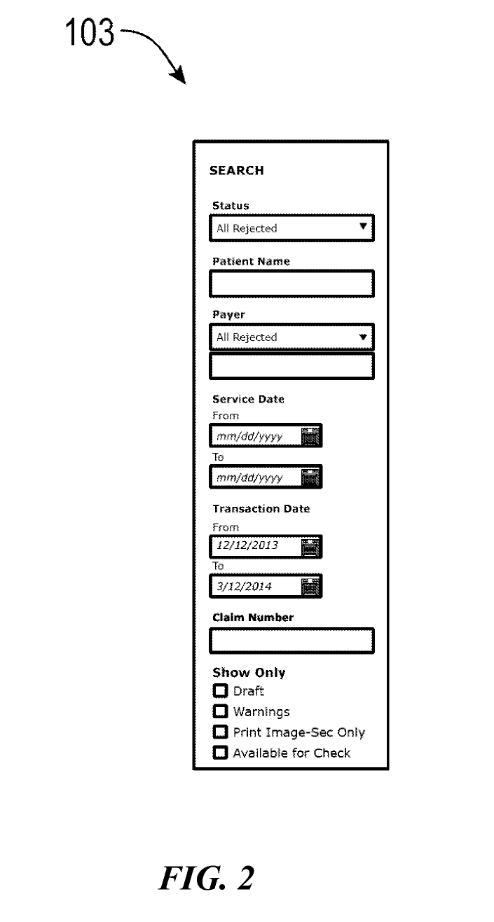

FIGS. 1-7 are screenshots from a first particular, non-limiting embodiment of a software system in accordance with the teachings herein. With reference to FIG. 1, the system is equipped with a portal 101 that includes features which enable a user to search for and display claims which meet certain user defined criteria. Thus, for example, in the embodiment depicted, the portal 101 is equipped with a search pane 103 (shown in greater detail in FIG. 2) which contains suitable menus and fields that allow a user to specify search parameters. These parameters permit the user to search for claims based, for example, on claim status, patient name, payer, service date range, transaction date range, or claim number. The searches performed by a user may be saved and later accessed via a “saved searched” menu 105.

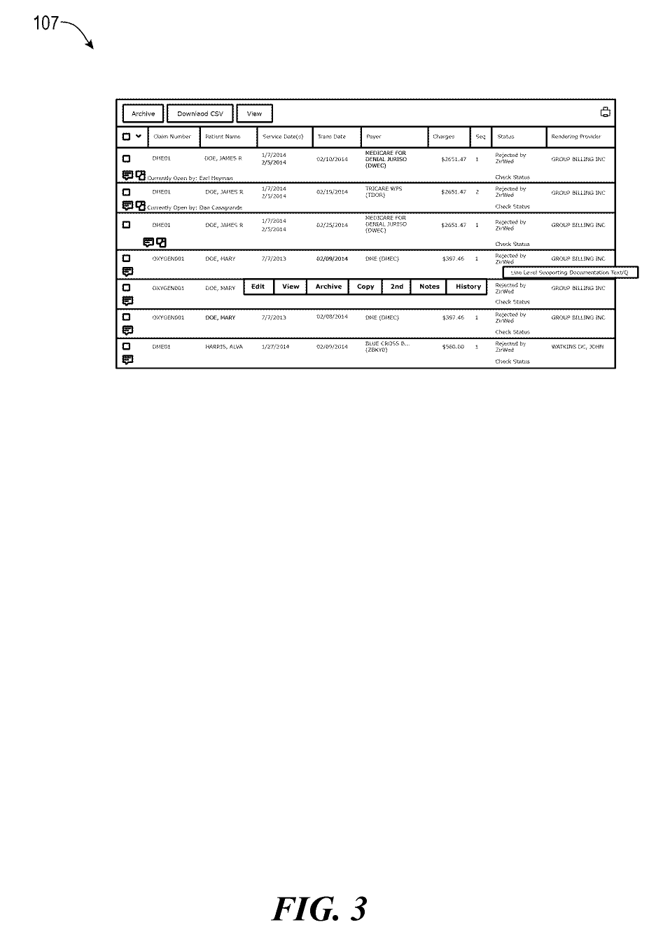

The search results are displayed in a search result pane 107 (shown in greater detail in FIG. 3). In the particular embodiment depicted, the search results are displayed in tabular format with various headings, including the claim number, patient's name, service dates, transaction dates, payer, charges, sequence number, status, and the name of the rendering provider. These headings, and their associated columns, are repositionable by the user. In some embodiments, selection of a heading by the user may cause the search results to be ordered in ascending and/or descending order based upon the parameter reflected in the heading. For example, selection of the claim number heading may cause all of the search results to be reorganized according to claim number, from smallest to largest. Reselection of the same heading may cause the search results to be reordered in the opposite fashion. For example, reselection of the claim number heading may cause all of the search results to be reorganized according to claim number, from largest to smallest. Suitable control features may also be provided in the search result pane 107 to allow the user to view a selected entry (e.g., claim) in the table, archive it, or download a CSV version of the claim.

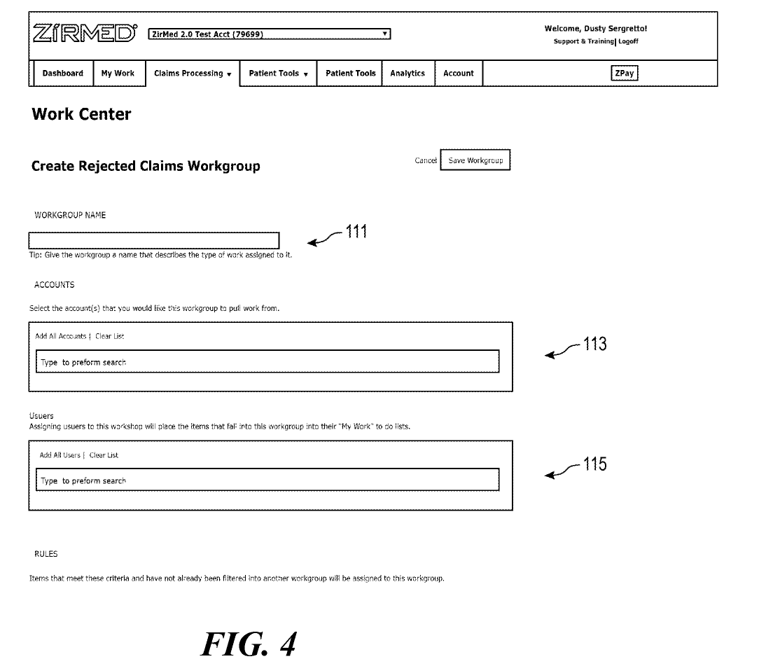

As seen in FIG. 4, after logging into the system, a user may create or customize a workgroup for how they want work to flow into the portal. Thus, as seen therein, the user has the option, when creating a workgroup, to give the workgroup a name 111, select accounts that the workgroup will pull work from 113, and assign workers to the workgroup 115. The latter two tasks may be accomplished by searching a listing or database of accounts or workers from a search window.

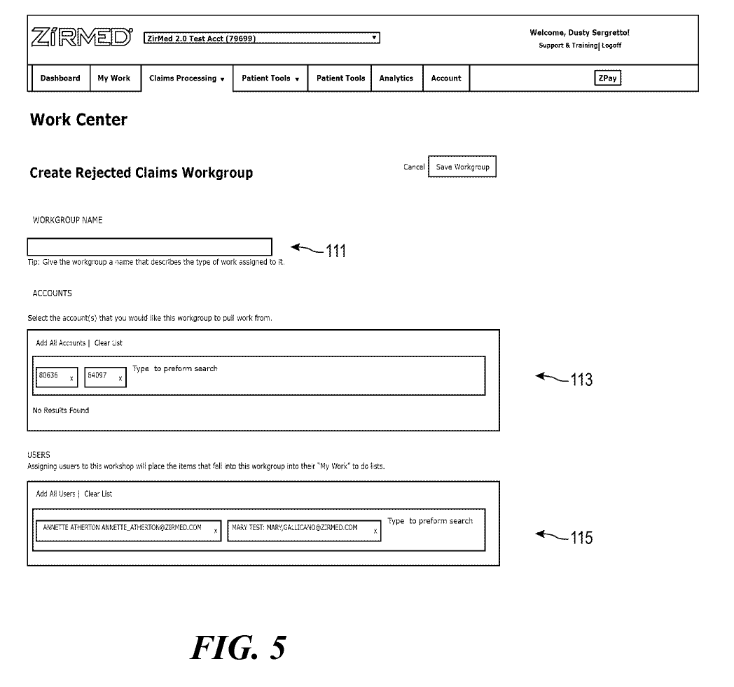

FIG. 5 depicts the window of FIG. 4 after accounts have been selected for the workgroup to pull work from, and after users have been selected to be assigned to the named workgroup. As seen therein, in the particular embodiment depicted, the field for the accounts that the workgroup will pull work from 113 has been populated with the selected accounts, and the field for the users to be assigned to the workgroup 115 has been populated with the selected users. After a workgroup has been created or modified in this manner, it may then be saved.

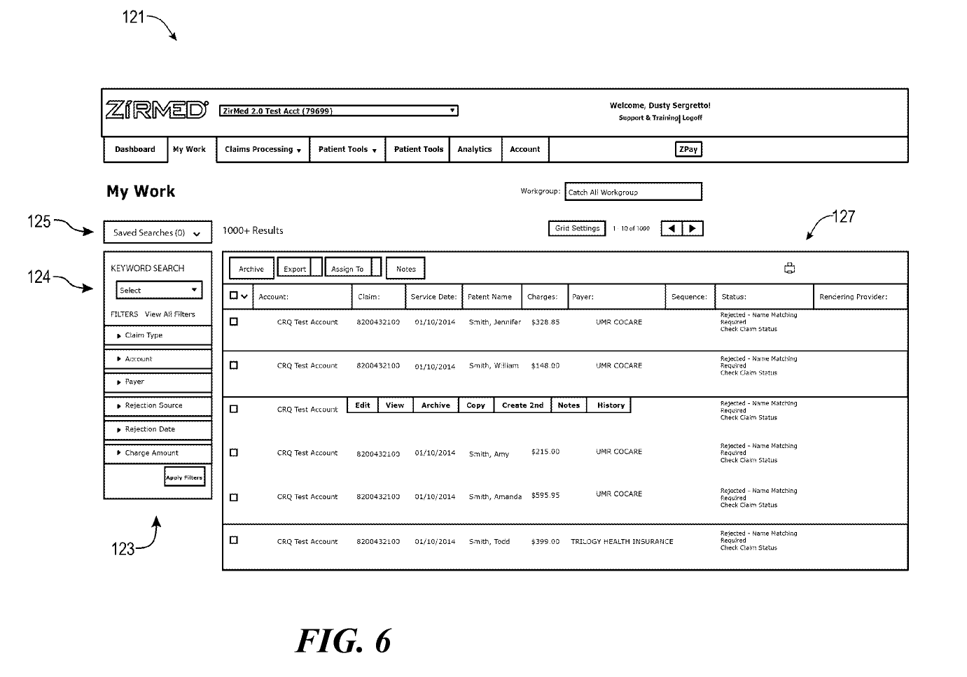

As seen in FIG. 6, after one or more workgroups are created, when a claims worker logs into the system, they may view a screen 121 (here called “My Work”) which displays, in a claims display pane 127, all of the claims from all of the workgroups the worker has been assigned to. The fields in the claims display pane 127 may be manipulated in a manner similar to those in the search result pane 107 of FIG. 1.

A search pane 123 is provided which is equipped with a variety of search filters to allow the worker to search the claims assigned to them. In the particular embodiment depicted, these include filters for claim type, account, payer, rejection source, rejection date and charge amount. A keyword search field 124 is also provided.

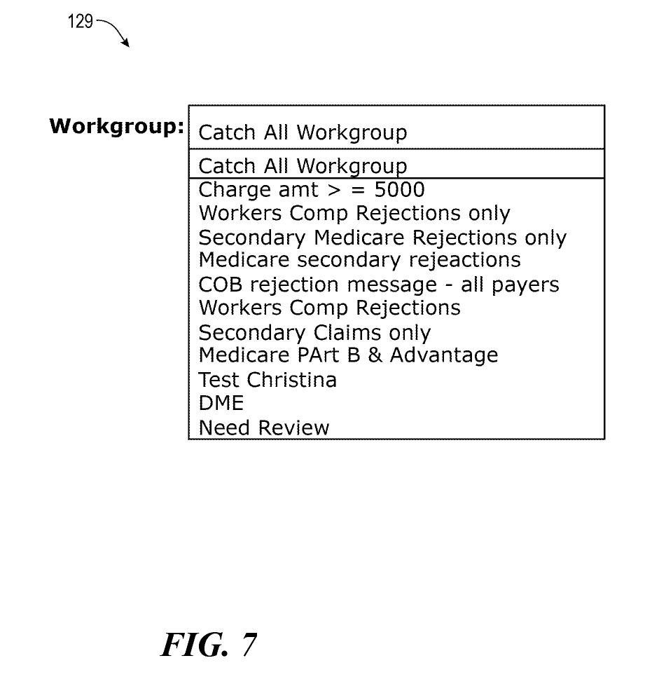

These searches may be saved by the worker with a descriptive title, so that the search may be easily repeated as necessary. The saved searches may be accessed via a “saved searched” menu 125. In addition, the worker may utilize a workgroup pull down menu 129 to navigate between the different workgroups. FIG. 7 depicts an example of the workgroup pull down menu 129 after it has been selected by the user.

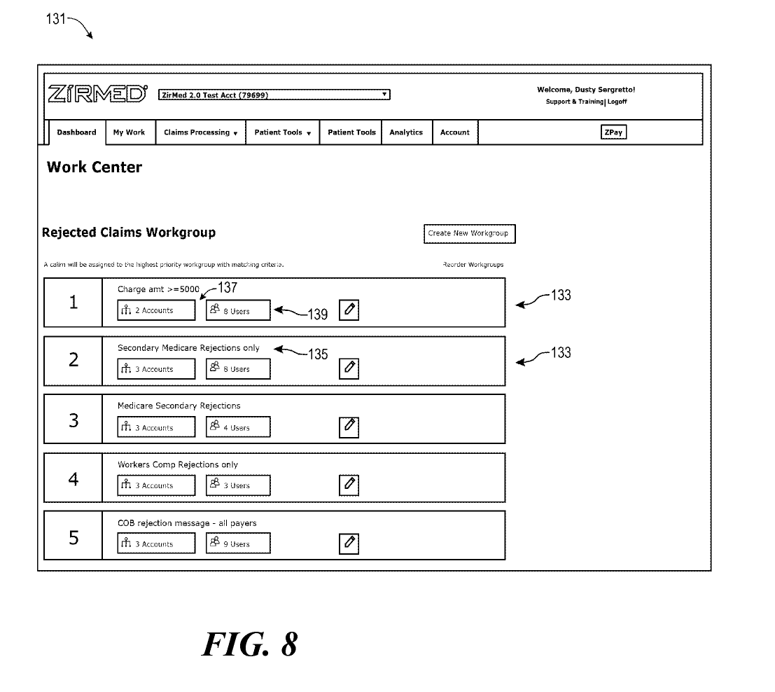

As seen in FIG. 8, a work center 131 is provided for viewing any existing workgroups 133 that have been defined on the system. In the particular embodiment depicted, each workgroup 133 has a textual description 135 which indicates the types of claims handled by the workgroup, a first field 137 which indicates the number of accounts handled by the workgroup, and a second field 139 which indicates the number of workers assigned to the group.

The workgroups 133 in this embodiment are prioritized so that a claim will be assigned to the highest priority workgroup with matching criteria. This allows, for example, a workers compensation rejection (which, in the example depicted, has been assigned a priority 4) to nonetheless be given top priority (priority 1) if the amount at issue is at least $5000. Hence, the prioritization scheme allows a manager to ensure that the most important claims are always being worked first through suitable definition of the priorities.

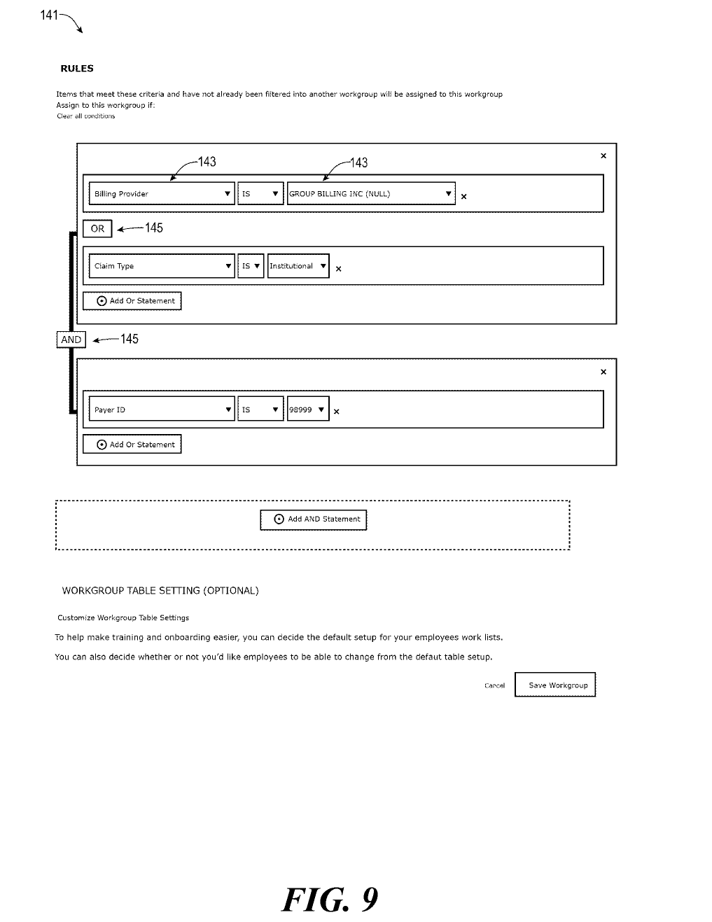

FIG. 9 depicts a rules window 141 which may be used to set the rules which define a workgroup. As seen therein, the parameters of the workgroup may be defined by selecting various menu parameters 143 and conjunctions 145 to form a Boolean query. The resulting query then determines which claims will fall into the workgroup. Terms of the query may include, for example, the billing provider, the claim type, the payer ID, or other suitable terms, as well as terms which may be specified by the user.

The particular embodiment of the software disclosed herein includes a menu bar 151 (see FIG. 1) which is preferably accessible from each working screen in the software. Preferably, the menu bar floats on top of, or does not overlap with, the windows used by a user to interact with the software.

The menu bar 151 includes a plurality of navigational links that allow the user to navigate to various screens of interest in the software program. In the particular embodiment depicted, these include links to screens which allow the user to access the software Dashboard (a starting screen), My Work (the work assigned to a worker), Claims Processing (claims processing functionalities), Patient Tools (a set of tools for patients), Clinical Link™ (a solution for the secure exchange of healthcare communications), Analytics (analytical tools which allow the user to analyze various aspects of claims and revenue cycle activities), Account (information about the user's account), and Z Pay™ (an online payment system available through the software).

The menu bar also includes other navigational aids. These include a “Support and Training Center” tab, the selection of which allows the user to navigate to instructional materials that teach the user how to use the software, and also offers information the user may utilize to obtain technical support. These navigational aids also include a login/logoff link which allows the user to respectively log into and log off of their account.

It will be appreciated that, while the systems and methodologies disclosed herein have been described with respect to their implementation in resolving issues with healthcare claims, they are more generally applicable to any situation in which work on a variety of projects must be prioritized. Moreover, it will be appreciated that, while the software described herein may be implemented as a standalone system, it may also be implemented as a module or program which is incorporated into another software system or suite.

In some embodiments, the systems, methodologies and software disclosed herein may be implemented on one or more computational devices. Such computational devices may include one or more hardware central processing units (CPU) that carry out the functions of the device, and may also comprise an operating system configured to perform executable instructions. Such computational devices may also have the ability to connect to, access or interface with a network, a cloud computing infrastructure, an intranet, and/or one or more data storage devices. Preferably, the computational device is connected to the Internet such that it accesses the World Wide Web.

Suitable computational devices that may be utilized to implement the systems, methodologies and software disclosed herein include, but are not limited to, server computers, desktop computers, laptop computers, notebook computers, sub-notebook computers, netbook computers, netpad computers, set-top computers, handheld computers, Internet appliances, mobile smartphones, tablet computers (including those with booklet, slate, and convertible configurations), personal digital assistants, video game consoles, and vehicles. One skilled in the art will appreciate that various smartphones, televisions, video players, and digital music players with optional computer network connectivity may be suitable for use in implementing the systems, methodologies and software disclosed herein.

In some embodiments, the computational device may include an operating system which is configured to perform executable instructions. Such an operating system may comprise, for example, software (including programs and data) which manages the hardware associated with the computational device and which provides services for the execution of applications. Suitable server operating systems which may be utilized for this purpose may include, but are not limited to, FreeBSD, OpenBSD, NetBSD®, Linux, Apple® Mac OS X Server®, Oracle® Solaris®, Windows Server®, and Novell® NetWare®. Suitable personal computer operating systems which may be utilized for this purpose may include, but are not limited to, Microsoft® Windows®, Apple® Mac OS X®, UNIX®, and UNIX-like operating systems such as GNU/Linux®. Suitable operating systems for smart phones and other mobile communications devices which may be utilized for this purpose may include, but are not limited to, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. In some embodiments of the systems and methodologies described herein, the operating system may be provided, in whole or in part, through cloud computing.

In some embodiments of the systems and methodologies described herein, the computational device may include, or have associated with it, one or more storage and/or memory devices. The storage and/or memory devices may consist of one or more physical devices used to store data or programs on a temporary or permanent basis. In some embodiments of the systems and methodologies described herein, one or more of the storage and/or memory devices may have a volatile memory and may require power to maintain information stored therein.

In other embodiments of the systems and methodologies described herein, the storage and/or memory devices may be equipped with non-volatile memory (such as, for example, flash memory) which retains information stored therein when the computational device is not powered. The non-volatile memory may comprise, for example, dynamic random-access memory (DRAM), ferroelectric random access memory (FRAM) or phase-change random access memory (PRAM).

In some embodiments of the systems and methodologies described herein, the computational device may be equipped with, or in communication with, various storage devices such as, for example, CD-ROMs, DVDs, flash memory devices, magnetic disk drives, magnetic tapes drives, optical disk drives, and cloud computing based storage. In further embodiments, the storage and/or memory device may comprise various combinations or sub-combinations of the foregoing devices.

In some embodiments of the systems and methodologies described herein, the computational device may include a display to communicate information visually to a user. The display may be, for example, a cathode ray tube (CRT) display, a liquid crystal display (LCD), a thin film transistor liquid crystal display (TFT-LCD), an organic light emitting diode (OLED) display, a plasma display, a video display, a heads-up display, or the like.

In some embodiments of the systems and methodologies described herein, the computational device may include or be equipped with one or more input devices to receive information from a user. Such input devices may include, for example, various tactile devices, keyboards, pointing devices (such as, for example, mice, trackballs, track pads, joysticks, game controllers, or styluses), touch screens or multi-touch screens, microphones, video cameras, or various combinations or sub-combinations of the foregoing input devices.

In some embodiments of the systems and methodologies described herein, the computational device may include a non-transitory, computer readable, and preferably tangible storage medium or media which is encoded with a program or other operating instructions that are executable by the operating system of the computational device or by another device that the computational device is in communication with. These instructions may include instructions for the purpose of implementing the systems and methods disclosed herein. In some embodiments, the computer readable storage medium may be removable from the computational device. The computer readable storage medium may include, but is not limited to, CD-ROMs, DVDs, flash memory devices, solid state memory, magnetic disk drives, magnetic tape drives, optical disk drives, cloud computing systems and services, and the like. The program or other operating instructions may be permanently, substantially permanently, semi-permanently, or non-transitorily encoded on the medium or media.

In some embodiments of the systems and methodologies described herein, the computational device may include one or more computer programs in the form of a sequence of instructions which are executable in the computational device's CPU, and which are written to perform a specified task. These computer readable instructions may be implemented as program modules, such as functions, objects, Application Programming Interfaces (APIs), data structures, and the like, that perform particular tasks or implement particular abstract data types, and may be written in various versions of various languages.

In the systems and methodologies described herein, the functionality of the computer program (or programs) or computer readable instructions may be combined or distributed as desired in various environments. For example, any computer program utilized in the systems and methodologies described herein may comprise one or more sequences of instructions which may be provided from one or more locations, and may include one or more software modules. In some embodiments, such a computer program may include, in part or in whole, one or more components selected from the group consisting of web applications, mobile applications, standalone applications, and web browser plug-ins, extensions, add-ins, and add-ons.

In some embodiments of the systems and methodologies described herein, such a computer program may include a web application which, in various embodiments, may utilize one or more software frameworks and one or more database systems. In some embodiments of the systems and methodologies disclosed herein, the web application may be created upon a software framework such as Microsoft® .NET or Ruby on Rails (RoR), and may utilize one or more database systems such as, for example, relational, non-relational, object oriented, associative, or XML database systems. Relational database systems that may be utilized may include, for example, Microsoft® SQL Server, mySQL™, and Oracle®. Moreover, the web application may be written in one or more versions of one or more languages such as, for example, markup languages, presentation definition languages, client-side scripting languages, server-side coding languages, database query languages, or various combinations or sub-combinations thereof.

In some embodiments of the systems and methodologies described herein, the web application may be written at least partially in (a) a markup language such as Hypertext Markup Language (HTML), Extensible Hypertext Markup Language (XHTML), or eXtensible Markup Language (XML); a presentation definition language such as, for example, Cascading Style Sheets (CSS); a client-side scripting language such as, for example, Asynchronous Javascript and XML (AJAX), Flash® Actionscript, Javascript, or Silverlight®; a server-side coding language such as, for example, Active Server Pages (ASP), ColdFusion, Perl, Java™, JavaServer Pages (JSP), Hypertext Preprocessor (PHP), Python™, Ruby, Tcl, Smalltalk, WebDNA®, or Groovy; or a database query language such as, for example, Structured Query Language (SQL).

In some embodiments of the systems and methodologies described herein, the web application may integrate enterprise server products such as, for example, IBM® Lotus Domino®. The web application may also include a media player element which may utilize one or more suitable multimedia technologies such as, for example, Adobe® Flash®, HTML 5, Apple® QuickTime®, Microsoft® Silverlight, Java™, or Unity®.

In some embodiments of the systems and methodologies described herein, a computer program may be utilized which includes a mobile application which is provided to a mobile computational device or mobile technology platform. The mobile application may be provided to the mobile computational device at the time it is manufactured or at a later time by way of download over a suitable network. The mobile application may be created by techniques known to the art using hardware, languages, and development environments which are also known to the art, and may be written in several languages. Suitable programming languages include, for example, C, C++, C#, Objective-C, Java™, Javascript, Pascal, Object Pascal, Python™, Ruby, VB.NET, WML, and XHTML/HTML with or without CSS, and various combinations or sub-combinations thereof.

Several mobile application development environments are known to the art and may be utilized in the development of the mobile application. These include, without limitation, AirplaySDK, alcheMo, Appcelerator®, Celsius, Bedrock, Flash Lite, .NET Compact Framework, Rhomobile, WorkLight Mobile Platform, Lazarus, MobiFlex, MoSync, and Phonegap. Several mobile device manufacturers also currently distribute software developer kits including, for example, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for the distribution of mobile applications. These include, for example, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, the systems and methodologies described herein may utilize a computer program which includes one or more standalone applications. Such standalone applications may be programs that are run as an independent computer process (that is, not as an add-on to an existing process, e.g., not a plug-in). Such standalone applications are often compiled. A compiler is a computer program(s) that transforms source code written in a programming language into binary object code such as assembly language or machine code. Suitable compiled programming languages may include, by way of example, C, C++, Objective-C, COBOL, Delphi, Eiffel, Java™, Lisp, Python™, Visual Basic, and VB .NET. Compilation is often performed, at least in part, to create an executable program. In some embodiments of the systems and methodologies described herein, the computer program may include one or more executable complied applications.

In some embodiments, the systems and methodologies described herein may include software, server, and/or database modules, or use of the same. Such software modules may be created by techniques known to the art (possibly by using machines, software, and languages known to the art), and may be implemented in various ways. These software modules may comprise one or more files, section of codes, programming objects, programming structures, or various combinations or sub-combinations thereof. In some embodiments of the systems and methodologies described herein, the software modules may comprise a web application, a mobile application, and/or a standalone application. The software modules may be present in one or more computer programs or applications, and may be hosted on one or more machines or cloud computing platforms which may be in one or more locations.

In some embodiments, the systems and methodologies described herein may include one or more databases, or use of the same. Such databases may include, for example, relational databases, non-relational databases, object oriented databases, object databases, entity-relationship model databases, associative databases, and XML databases. These databases may be Internet-based, web-based, cloud computing-based, or may be based on one or more local computer storage devices.

Some aspects of embodiments of the systems and methodologies disclosed herein may be found at http://public.zirmed.com/solutions-overview/revenue-cycle-management/zirmed-workeenter/, which is incorporated herein by reference in its entirety along with any referenced or embedded pages, documents or videos.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. The subject matter of any of these claims may be combined in various combinations without departing from the scope of invention. By way of example, the subject matter of two or more dependent claims may be combined with the subject matter of any independent claim without departing from the scope of the invention, even if the claims being combined are not dependent on each other in the appended claims.

1-15. (canceled)

16. A method for processing health insurance claims, comprising:
providing a server equipped with a portal, wherein a plurality of healthcare providers are in communication with the server by way of said portal, and wherein the server is equipped with software which allows a user to edit healthcare claims;
receiving rejected or denied healthcare claims through the portal from a plurality of source systems running a plurality of distinct healthcare practice management programs;
in response to inputs made by a user of the software, editing the healthcare claims, thereby producing a plurality of edited claims; and
propagating the edited claims to the plurality of source systems.

17. The method of claim 16, wherein propagating the edited claims to the plurality of source systems includes:
tracking the changes made to the claims during the editing step; and
replicating the changes to the corresponding claims in the plurality of source systems.

18. The method of claim 16, wherein the software is equipped with a worker group definition function which allows a user of the software to define groups of workers to which claims received through the portal are assigned.

19. The method of claim 18, further comprising:
defining a plurality of worker groups with the software to which claims received through the portal are assigned.

20. The method of claim 19, wherein defining a plurality of worker groups with the software includes assigning workers to the group, and defining the types of claims to be assigned to the group.

21. The method of claim 19, further comprising:
assigning each of the claims received through the portal to one of said worker groups.

22. The method of claim 21, further comprising:
defining a set of priority rules with the software which determines the priority assigned to each claim received through the portal; and
arranging the claims assigned to each worker group in order of priority based on the priority rules, thereby creating a prioritized claims listing.

23. The method of claim 22, further comprising:
displaying the prioritized claims listing on a display associated with at least one member of the group to which the claims in the prioritized claims listing have been assigned.

24. The method of claim 22, further comprising:
printing, on a paper medium, the prioritized claims listing associated with at least one member of the group to which the claims in the prioritized claims listing have been assigned.

25. The method of claim 22, further comprising:
presenting claims from the prioritized claims listing to at least one member of the worker group to which the claims in the prioritized claims listing have been assigned, wherein the claims are presented in the order in which the claims were prioritized.

26. The method of claim 25, further comprising:
receiving inputs from the at least one member in the form of edits to the claims in the prioritized claims listing.

27. The method of claim 26, wherein the software is equipped with a resubmit hyperlink, the selection of which by a user causes an edited claim to be resubmitted to a payer for reconsideration.

28. The method of claim 27, further comprising:
receiving, from a user, input indicating selection of the resubmit hyperlink; and
in response to the input, resubmitting a claim associated with the resubmit hyperlink to a payer for reconsideration.

29. The method of claim 16, wherein the server is associated with a revenue cycle management company.

30. The method of claim 16, wherein the received claims are claims which have been sent to a revenue management cycle company for processing the managed by a revenue cycle management company.

31. (canceled)

32. A method for processing health insurance claims, comprising:
providing a server equipped with a portal, wherein a plurality of healthcare providers are in communication with the server by way of said portal, and wherein the server is equipped with software which allows a user to edit healthcare claims received through the portal;
defining a plurality of worker groups to which claims received through the portal are assigned, wherein defining a plurality of worker groups with the software includes assigning workers to each of the plurality of worker groups, and defining the types of claims to be assigned to each of the plurality of worker groups;
defining a set of priority rules with the software which determines the priority assigned to each claim received through the portal;
receiving rejected or denied healthcare claims through the portal from a plurality of source systems running a plurality of distinct healthcare practice management programs;
assigning each of the claims received through the portal to one of said worker groups;
arranging the claims assigned to each worker group in order of priority based on the priority rules, thereby creating a prioritized claims listing;
presenting claims from the prioritized claims listing to at least one member of the worker group to which the claims in the prioritized claims listing have been assigned, wherein the claims are presented in the order in which the claims were prioritized;
receiving inputs from the at least one member in the form of edits to the claims in the prioritized claims listing;
in response to inputs made by a user of the software, editing the healthcare claims, thereby producing a plurality of edited claims; and
propagating the edited claims to the plurality of source systems.

33. A tangible, non-transitive, computer readable medium having programming instructions recorded therein which, when executed by at least one processor, perform the method of:
creating a portal on a server associated with a revenue cycle management company, wherein a plurality of healthcare providers are in communication with the server by way of said portal, and wherein the server is equipped with software which allows a user to edit healthcare claims;
receiving rejected or denied healthcare claims through the portal from a plurality of source systems running a plurality of distinct healthcare practice management programs;
editing the healthcare claims in response to inputs from a party assigned to work the claim, thereby producing a plurality of edited claims; and
propagating the edited claims to the plurality of source systems.

34. The method of claim 32, wherein the server is associated with a revenue cycle management company.

35. The method of claim 32, wherein the received claims are claims which have been sent to a revenue management cycle company for processing the managed by a revenue cycle management company.

36. The method of claim 32, wherein the software is equipped with a resubmit hyperlink, the selection of which by a user causes an edited claim to be resubmitted to a payer for reconsideration, and further comprising:
receiving, from a user, input indicating selection of the resubmit hyperlink; and
in response to the input, resubmitting a claim associated with the resubmit hyperlink to a payer for reconsideration.
